(19) United States
(12) Patent Application Publication
(10) Pub. No.: US 2001/0031107 A1
(43) Pub. Date: Oct. 18, 2001

(54) Wavelength selector for optical performance monitor

(76) Inventor: Scott H. Bradshaw, Ottawa (CA)

Correspondence Address: TOWNSEND AND TOWNSEND AND CREW, TWO EMBARCADERO CENTER, EIGHTH FLOOR, SAN FRANCISCO, CA, 94111-3834, US

(21) Appl. No.: 09/839,809

(22) Filed: Apr. 19, 2001

Related U.S. Application Data
(60) Provisional application No. 60/199,909, filed on Apr. 26, 2000.

(51) Int. Cl. G02F 1/295; G02F 1/13; G02B 26/02; G02F 1/29; G02B 27/44; G02B 26/08; G02B 5/18

(52) U.S. Cl. 385/10; 359/566; 359/227; 349/196; 359/302

(57) ABSTRACT

A multiwavelength selector for use with a high speed performance monitor, that uses a spatial wavelength separator, a configurable spatial filter, a focusing assembly, and a photodetector to select a wavelength or wavelengths from a plurality of incoming wavelengths, for further processing by said high speed performance monitor. The invention is intended for use in a fiber optic network application.

### BACKGROUND OF THE INVENTION

The invention relates to optical communication instrumentation and more particularly to an optical switch for selecting a desired wavelength in an optical performance monitor.

With increasing demand for telecommunications bandwidth, there is a need for performance monitors that assess the quality of an optical signal at an intermediate or end point of an optical link. The information gathered can be used during link construction to aid troubleshooting or while the link is functioning to aid dynamic allocation of optical bandwidth. For example, the information can be used to locate a fault in an optical link or determine when an optical signal needs to be regenerated.

Complete signal monitoring includes observation of both DC information, such as signal power level, noise floor level, including signal to noise ratio, (SNR), wavelength drift from the International Telecommunications Union (ITU) grid-specified wavelength, as well as AC information, such as jitter, signal extinction ratio, and bit error ratio (BER). A switch for processing various inputs is desirable and, perhaps, necessary to monitor multiwavelength, high-speed performance optical communication. One approach is to separate the incoming light into its constituent wavelengths, with an appropriate resolution, and then detect each constituent with a high speed detector. Once this is done, the resulting electrical signal for each wavelength can be processed by building a separate high speed processing chain for each wavelength, but this is expensive. Another approach is to switch the signal at some point in the electrical domain, thus allowing a single high speed processing chain to process all wavelengths. This is also difficult, however, since switching of analog RF signals is generally done mechanically by brute force disconnection of one line and subsequent connection of another, so that the solution again becomes cumbersome and expensive. It would therefore be desirable to accomplish this switching function while the signal is in the optical domain, and present the resulting selected wavelength to a single (and therefore relatively inexpensive) electrical processing chain.

There are a number of conventional approaches that accomplish this switching function in the optical domain, which are designed to address the DC monitoring issues. However, when these approaches are extended to retrieve AC information several difficulties arise.

FIG. 1A illustrates an embodiment of a conventional wavelength performance monitor 10. The device is essentially a compact optical spectrum analyzer that uses a simple monochromator. The monchromator may be constructed using a diffraction grating 12 in combination with a lens 14, an input slit 16 and an output slit 18 to separate the wavelengths in the incoming light. In this device, the spectral content of the incoming optical signal 20 is spatially separated according to its component wavelengths, and the relative intensities of the constituent signals are sampled by rotating the grating 12 about an axis of rotation 22 so that the wavelengths are scanned across the output slit 18 and detected by a photodetector 24. Alternatively, the grating 12 is fixed, and the output slit 18 and photodetector can be scanned across the wavelengths. This approach requires very sensitive control over the rotation of the grating 12, and this in turn leads to increased cost.

FIG. 1B illustrates another conventional embodiment of a performance monitor 11 where the input slit of FIG. 1A is replaced by a fiber waveguide 26, and the output slit is replaced by an array 28 of detectors 30. Each of the detectors sees a different spectral slice of the input light source. The advantage of this approach is that there are no moving parts, which increases reliability and repeatability. The disadvantage of this approach is that many photodetector signals need to be processed, instead of just one, leading to the difficulties of processing many electrical signals discussed above. Furthermore, this approach can introduce distortion, as will be described herein.

What is needed, therefore, is a more practical approach to monitoring both AC and DC signal information.

### SUMMARY OF THE INVENTION

The present invention is a multiwavelength high speed performance monitor that uses a spatial wavelength separator, a configurable spatial filter, a focusing assembly, and a photodetector to assess the quality of an optical signal at an intermediate or end point of an optical link. According to the invention, a wavelength separator selects a single desired wavelength in the optical domain. Then, a wavelength selector operating in conjunction with a focusing system directs a single or narrow beam with the desired wavelength to a detector.

In a specific embodiment, a spatial wavelength separator chromatically spreads a multiwavelength optical energy input beam so as to spatially separate the wavelengths. The separated optical wavelengths are then processed through a configurable spatial filter. The configurable spatial filter blocks all but the desired wavelength, thus permitting only the selected wavelength to be incident onto a photodetector. The configurable spatial filter has a blocking element that is placed in the apparatus after the optical wavelength spatial separation element and before the photodetector. Its function is to select which wavelength is to be allowed and which wavelengths are to be blocked, based on spatial position. The wavelength selector element is arranged so that any phase distortion caused by the wavelength separator is reversed before the signal is incident on the photodectector The present invention provides a method and apparatus that can feasibly perform multiwavelength high speed monitoring.

The invention will be better understood by reference to the detailed description of specific embodiments in connection with the accompanying drawings.

### BRIEF DESCRIPTION OF THE DRAWINGS

FIG. 1A illustrates a prior art monochromator constructed from using a diffraction grating in combination with a lens, an input slit and an exit slit to separate wavelengths according to the prior art.

FIG. 1B shows a prior art monochromator constructed from using a diffraction grating in combination with a lens, a fiber waveguide input and an array of detectors at an exit.

FIG. 2 is a block diagram illustrating the invention.

FIG. 3A illustrates a first embodiment of the invention.

FIG. 3B illustrates a second embodiment of the invention.

FIG. 4 is a close up view of a mirror and configurable slit combination according to one embodiment of the invention.

FIG. 5 shows another embodiment of the claimed invention illustrating microelectromechanical (MEM) shutters.

### DESCRIPTION OF SPECIFIC EMBODIMENTS

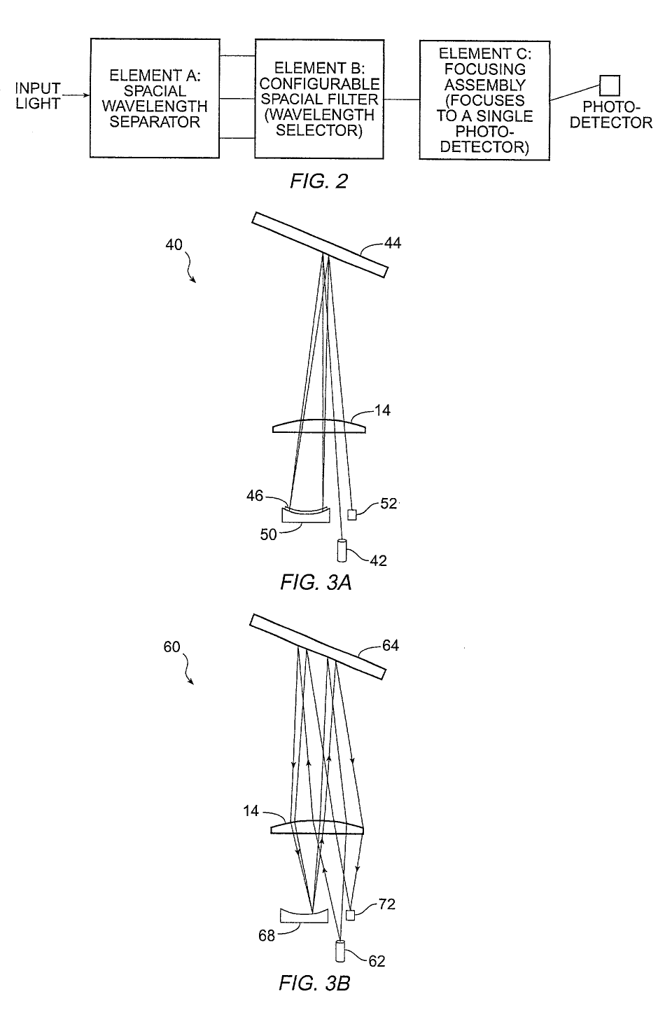

FIG. 2 illustrates the concept of the claimed invention in a block diagram flow chart. The source light is separated by a wavelength separator, then all but one spectral slice are blocked by the configurable spatial filter (wavelength selector), the resulting chosen slice is focused and projected onto the photodetector.

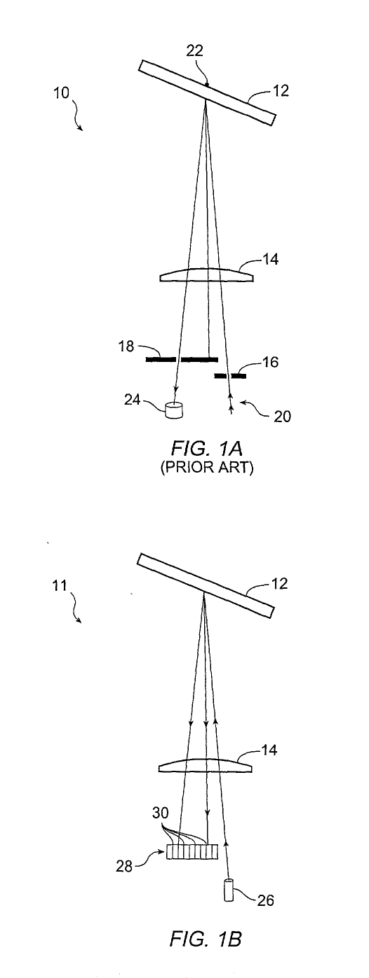

FIG. 3A shows an embodiment 40 of the present invention. In this embodiment, the central rays of two wavelengths on an input fiber 42 are traced through the optics. The two rays are incident on a diffraction grating 44, which creates an angular separation between different wavelengths. This is similar to the conventional embodiment shown in FIG. 1b, except that the resulting separated rays are then incident on a configurable slit 46, followed by a curved mirror 50. The radius of curvature is chosen so the angularly separated rays from the diffraction grating are focused back to the same point or a point very near on the grating 44. The mirror 50 is tilted slightly, so that the reflected rays go back through the optics and are imaged onto a detector 52 placed near the input fiber 42, rather than back into the input fiber. Several advantages of this arrangement include compact size (achieved by re-using the optics to focus the separated light back onto the photodetector), and a reversal of phase distortion caused by one reflection on the diffraction grating. Also, since all the incoming wavelengths are ultimately focused onto a single point, a only single detector is needed.

The phase distortion advantage as described above is illustrated in more detail in FIG. 3B. As illustrated, two extreme rays of light from a single wavelength on the input are followed through the optics. After its forward propagation from the fiber 62 to the mirror 68, the ray marked with arrows has traced a longer path than the unmarked extreme ray. However, through its reverse path from the mirror back to the detector 72, this ray follows the shortest path, while the other extreme ray, which followed the shortest path on the way in, follows the longest path on the way out. Thus the phase distortion introduced by the diffraction grating 64 is compensated before the light is focused onto the photodetector 72. A similar function could be achieved by using two diffraction gratings, but this would require a larger overall device size and increase the complexity.

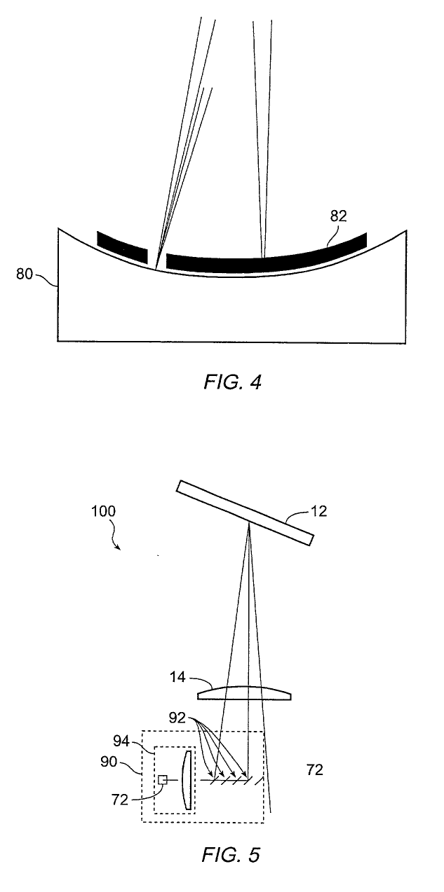

FIG. 4 shows a close up view of the mirror 80 and configurable slit 82 combination. One choice for the configurable slit 82 would be to coat the mirror 80 with a liquid crystal attenuator array, or put the array in close proximity to the mirror. The pixels could then be selected electronically, either one pixel at a time for maximum DC resolution, or with software control, several pixels could be opened simultaneously to allow one complete wavelength signal through the device, while still blocking all other channels. This would be advantageous for AC monitoring, both to increase the signal strength, and to reduce signal distortion. Distortion could result because the wavelength has had its frequency components separated spatially, so that selectively allowing only the center of the signal through would preferentially “clip” the high frequency components of the signal. The consequence of this would be that the resulting detected AC waveform would appear to have gone through a high frequency filter.

Although a liquid crystal display (LCD) array was discussed, the spatial filter could be made in other ways, including, but not restricted to, an array of microelectromechanical (MEM) beamstops or mechanically driven slit.

FIG. 5 shows another embodiment 100 of the claimed invention. As illustrated in FIG. 5, a single mirror is not the only way to implement the present invention, a MEM array 90 is used in place of a single mirror. In the MEM array, each of the mirrors 92 of the array is carefully controlled mechanically by a mechanism 94 so that each wavelength is correctly focused onto the detector. This arrangement does not address phase distortion, nor does it allow for a variable number of pixels to be opened simultaneously. However, these issues could be addressed by staggering the mirrors on a diagonal (so that multiple pixels can be opened simultaneously), and by including a double reflection from two separate diffraction gratings (to remove phase distortion).

Finally, the diffraction grating is not the only choice available for wavelength separation; other examples include arrayed waveguide gratings, and dielectric filters.

As will be understood by those skilled in the art, the present invention may be embodied in other specific forms without departing from the essential characteristics thereof. Accordingly, the foregoing description is intended to be illustrative, but not limiting, of the scope of the invention which is set forth in the following claims.

What is claimed is:

1. A wavelength selector apparatus for selecting in an optical domain a wavelength from a plurality of wavelengths, the apparatus comprising:
a spatial wavelength separator for separating the plurality of wavelengths in space; and
a configurable shutter for selecting said wavelength from the plurality of wavelengths.

2. The apparatus of claim 1, further comprising:
a focusing mechanism for focusing said wavelength onto a photodetector at a fixed location, wherein the focusing mechanism is designed to perform said focusing for a range of wavelengths.

3. The apparatus of claim 2, wherein elements are arranged to cancel any phase distortion induced by dispersive elements.

4. The apparatus of claim 2, wherein the focusing mechanism comprises a mirror, the mirror reflecting back said wavelength through the configurable shutter in a way such that optics of the apparatus are re-used, and a compact implementation of the apparatus is achieved.

5. The apparatus of claim 4, wherein said wavelength is reflected back through dispersive elements so as to reverse any phase distortion introduced thereby.

6. The apparatus of claim 4, wherein the mirror is curved to compensate for angular separation caused by the spatial wavelength separator in such a way that said wavelength is reflected onto the fixed location of the photodetector.

7. The apparatus of claim 6, wherein the curved mirror is at a tilt so that the fixed location of the photodetector is offset from an input fiber for the plurality of wavelengths.

8. The apparatus of claim 1, wherein the configurable shutter is comprised of an array of pixels that are controllable to be either transmitting or blocking.

9. The apparatus of claim 4, wherein said wavelength is reflected back through dispersive elements so as to reverse any phase distortion introduced thereby.

10. The apparatus of claim 8, wherein the pixels comprise liquid crystal pixels.

11. The apparatus of claim 8, wherein the pixels comprise microelectromechanical (MEM) shutters.

12. The apparatus of claim 1, wherein the spatial wavelength separator comprises a diffraction grating.

13. The apparatus of claim 1, further comprising:
a control module for controlling and adjusting the selector pixels.

14. The apparatus of claim 13, wherein the control module is programmed to adjust a position of an opening in the spatial filter in order to compensate for drift of said wavelength.

15. The apparatus of claim 13, wherein the control module is programmed to adjust a width of the opening in the spatial filter.

16. The apparatus of claim 15, wherein the width of the opening is adjusted to avoid distortion of high frequency data carried on said wavelength.

17. The apparatus of claim 15, wherein the width of the opening is reduced to increase a (DC) spatial resolution of the apparatus.

18. The apparatus of claim 1, wherein the apparatus is part of a performance monitoring device.

19. A method for selecting in an optical domain a wavelength from a plurality of wavelengths in an optical signal, the method comprising:
separating the plurality of wavelengths in space;
selecting a beam of a desired wavelength from the plurality of wavelengths in space;
focusing the beam of said desired wavelength; and
directing the beam of said desired wavelength to a detector.
